(19) United States
(12) Patent Application Publication
(10) Pub. No.: US 2025/0111581 A1
(43) Pub. Date: Apr. 3, 2025

(54) LEARNING BASED TWO-DIMENSIONAL (2D) SHAPE PACKING

(71) Applicant: Tencent America LLC, Palo Alto, CA (US)

(72) Inventors: Zherong PAN, Bellevue, WA (US); Xifeng GAO, Tallahassee, FL (US); Kui WU, Los Angeles, CA (US)

(73) Assignee: Tencent America LLC, Palo Alto, CA (US)

(21) Appl. No.: 18/376,324

(22) Filed: Oct. 3, 2023

(51) Int. Cl. G06T 15/04

(52) U.S. Cl. CPC G06T 15/04

(57) ABSTRACT

A plurality of UV patches of a three-dimensional model is divided into a primary set of the UV patches and a secondary set of the UV patches based on a patch size threshold. The UV patches of the primary set are grouped into a plurality of super-patches. Each of the plurality of super-patches includes different UV patches in the primary set that are packed together in a predefined shape. The plurality of super-patches is assembled together into a first bounding box. Poses of the plurality of super-patches are adjusted to reduce spacing between the plurality of super-patches. Gaps between the UV patches in the primary set are filled with the UV patches in the secondary set.

### TECHNICAL FIELD

The present disclosure includes aspects related to packing patches derived from a three-dimensional (3D) model in a texture space.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

2D irregular shape packing is a necessary step to arrange UV patches of a 3D model within a texture atlas for memory-efficient appearance rendering in computer graphics. Being a joint and combinatorial decision-making problem involving patch positions and orientations, this problem has well-known NP-hard complexity. In related solutions, a heuristic packing order is assumed or an upstream mesh cut and a UV mapping are modified to simplify the problem, which can either limit a packing ratio or incur robustness or generality issues.

### SUMMARY

Aspects of the disclosure include methods, apparatuses, and non-transitory computer-readable storage mediums for patch packing. In some examples, an apparatus for patch packing includes processing circuitry.

According to an aspect of the disclosure, a method of processing a plurality of UV patches in a three-dimensional model is provided. In the method, the plurality of UV patches is divided into a primary set of the UV patches and a secondary set of the UV patches based on a patch size threshold. The UV patches of the primary set are grouped into a plurality of super-patches. Each of the plurality of super-patches includes different UV patches in the primary set that are packed together in a predefined shape. The plurality of super-patches is assembled together into a first bounding box. Poses of the plurality of super-patches are adjusted to reduce spacing between the plurality of super-patches. Gaps between the UV patches in the primary set are filled with the UV patches in the secondary set.

In an example, based on a high-level group selector network (HSN) configured to identify a subset from the primary set to from a super-patch of the plurality of super-patches, M subsets are selected from the primary set. Each of the M subsets includes respective N UV patches, where the M is a first positive integer, and the N is a second positive integer smaller than M. An estimated area-averaged packing ratio associated with each of the M subsets is determined. The M subsets is reordered based on the estimated area-averaged packing ratios. L subsets are determined from the M subsets that correspond to L largest estimated area-averaged packing ratios.

In an example, the UV patches in each of the L subsets are packed together into a respective subset bounding box. An area-averaged packing ratio associated with each of the packed L subsets is determined. A first super-patch of the plurality of super-patches is determined from the packed L subsets. The first super-patch corresponds to a largest area-averaged packing ratio among the determined area-averaged packing ratios of the packed L subsets.

In an aspect, the UV patches in a first subset of the L subsets is packed into a first subset bounding box. For example, based on a low-level sorter network (LSN) that is configured to determine a packing order of the UV patches in the first subset, the UV patches in the first subset are organized into a connected graph in which already-packed patches and to-be-packed patches of the first subset are connected to each other. Node features of the UV patches in the first subset are input into a graph attention network (GAT) to obtain graph features of the UV patches of the first subset. The graph features are converted to corresponding Q-values via a multilayer perceptron (MLP) that includes an input layer and an output layer, and one or more hidden layers with stacked neurons. A first one of the to-be-packed patches is determined to pack to the already-packed patches based on the Q-values.

In an example, the node features of the UV patches of the first subset are determined based on a fully convolutional network (FCN) in which the UV patches of the first subset are encoded into a F-dimensional latent space, where the F is a positive integer.

In an aspect, based on a low-level pose network (LPN) that is configured to determine a pose of a UV patch in the primary set, a state space is determined. The state space indicates position states of the already-packed patches and the to-be-packed patches in the first subset. An action space for the to-be-packed patches is determined. The action space indicates candidate packing actions for the to-be-packed patches. Each of the candidate packing actions in the action space is applied on the first one of the to-be-packed patches. An updated state space corresponding to each of the candidate packing actions that is applied on the first one of the to-be-packed patches is determined. A reward value corresponding to each of the updated state spaces associated with the first one of the to-be-packed patches is determined. Each of the reward values corresponds to an area-average packing ratio associated with the respective candidate packing action. A packing action is determined from the candidate packing actions in the action space that corresponds to a largest reward value of the reward values. The first one of the to-be-packed patches is packed by adjusting a pose and a distance of the first one of the to-be-packed patches according to the determined packing action.

In an example, the determined packing action includes a translation action to reduce the spacing between the first one of the to-be-packed patches and the already-packed patches and a rotation action to adjust a pose of the first one of the to-be-packed patches. The determined packing action is applied to the first one of the to-be-packed patches according to a collision-constrained local optimization such that a center-of-mass (COM) of the first one of the to-be-packed patches and a COM of the already-packed patches is reduced to a predetermined value and the first one of the to-be-packed patches and the already-packed patches are not overlapped.

In an example, a packing ratio of the packed first subset of the packed L subsets is determined based on a ratio of an area of the first subset and an area of the first bounding box of the packed first subset. The area-averaged packing ratio associated with the packed first subset of the packed L subsets is determined based on a ratio of (i) a sum of areas of the UV patches in the super-patches that includes the packed first subset in the primary set and (ii) a sum of areas of subset bounding boxes of the super-patches that includes the packed first subset in the primary set.

In an aspect, the LPN is trained based on a Q-learning algorithm by maximizing an expected cumulative reward value. The expected cumulative reward value is defined as follows:

$${π}^{L P N} [ {Σ}_{i = 1}^{H} r ( {s}_{i} , {a}_{i} , {s}_{i + 1} ) ] .$$

i indicates an i-th patch of the to-be-packed patches. aᵢ indicates a determined packing action from the candidate packing actions that is applied to the i-th patch. r (sᵢ, aᵢ, sᵢ₊₁) indicates a reward value in response to the determined packing action being applied to the i-th patch. π^{LPN} indicates a probability that the determined packing action aᵢ is selected from the candidate packing actions. sᵢ indicates a state space before the i-th patch is packed to the already-packed patches. sᵢ₊₁ indicates a state space after the i-th patch is packed to the already-packed patches.

In an aspect, the HSN is trained. In order to train the HSN, a first estimated area-averaged packing ratio is determined for a first training subset from the primary set and a second estimated area-averaged packing ratio is determined for a second training subset from the primary set. A first area-averaged packing ratio for the first training subset and a second area-averaged packing ratio for the second training subset are further determined. The HSN is updated via a margin ranking loss, where the margin ranking loss being equal to:

$$ℒ = max ( 0 , - sg n ( {pr}^{′} - {pr}^{″} ) ( HSN ( {′}^{} ) - HSN ( {″}^{} ) ) + ϵ ) .$$

pr′ and HSN ( [symbol] ′) are the first area-averaged packing ratio and the first estimated area-averaged packing ratio for the first subset respectively. pr″ and HSN ( [symbol] ″) are the second area-averaged packing ratio and the second estimated area-averaged packing ratio for the second subset respectively. ∈ is a minimal positive margin.

In an example, the poses of the plurality of super-patches are adjusted by rotating and translating the plurality of the super-patches such that the spacing between the plurality of super-patches is reduced such that the first bounding box is reduced into a second bounding box. The second bounding box corresponds to a minimized bounding size according to an optimization function such that the plurality of super-patches in the second bounding box are not overlapped.

According to another aspect of the disclosure, an apparatus is provided. The apparatus includes processing circuitry. The processing circuitry can be configured to perform any one or a combination of the methods for packing patches derived from a 3D model in a same texture space.

Aspects of the disclosure also provide a non-transitory computer-readable medium storing instructions which when executed by at least one processor cause the at least one processor to perform any one or a combination of the methods for packing patches derived from a 3D model in a same texture space.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a pipeline to pack patches derived from a three-dimensional (3D) model in a same texture space accordance with some embodiments.

FIG. 2 is a schematic illustration of an action space in accordance with some embodiments.

FIG. 3 is an illustration of forming an alpha shape in accordance with some embodiments.

FIG. 4 is a schematic illustration of patch squeezing and gap removal in accordance with some embodiments.

FIG. 5 is an exemplary 3D model dataset in accordance with some embodiments.

FIG. 6 is a first exemplary packing ratio comparison between related examples and a method of the disclosure in accordance with some embodiments.

FIG. 7 is a second exemplary packing ratio comparison between the related examples and the method of the disclosure in accordance with some embodiments.

FIG. 8 is an exemplary average packing time comparison between the related examples and the method of the disclosure in accordance with some embodiments.

FIG. 9 is a third exemplary packing ratio comparison between the related examples and the method of the disclosure in accordance with some embodiments.

FIG. 10 is a flow chart outlining an exemplary process for packing patches according to some embodiments of the disclosure.

FIG. 11 is a schematic illustration of a computer system in accordance with an embodiment.

### DETAILED DESCRIPTION OF EMBODIMENTS

In the disclosure, UV unwrapping can include a process of mapping 3D models onto 3D surfaces. UV patch/chart can include a part of the 3D model cut (or derived) from a full model. UV packing can include a process of putting UV patches in a same texture space, for example as tightly as possible.

In related examples, open-source software, such as Blender and Xatlas, can be applied to pack patches. For example, Blender and Xatlas can combine multiple heuristic strategies to pack UV charts together. In the related examples, a heuristic method can also be provided for packing UV charts. The heuristic method can generate multi-chart geometry images (MCGI). The heuristic method can compute a top-horizon of an already-packed UV charts. Given a new UV chart, the method can heuristically check every horizontal position on a top-horizon. The heuristic method can then choose a lowest position on the top-horizon. In the related examples, a revised version of the heuristic method can also be provided. In the revised heuristic method, each new UV chart can be placed at several orientations. According to the revised heuristic method, a new heuristic score function can be provided. The new heuristic score function can measure a wasted area and choose a placement to minimize the wasted area. In addition, UV charts are allowed to wrap around a texture image boundary. No Fit Polygon (NFP) is a fundamental geometric algorithm that can be used to find all possible collision-free positions to put a UV patch around a set of existing patches. The NFP algorithm may not work alone to complete the UV packing task. For example, UV patches may need to be ordered to be placed one-by-one.

In the disclosure, a learning-assisted 2D irregular shape packing method is provided. The method can achieve a high packing quality with reduced requirements from the input. Subsets of UV patches can be iteratively selected and grouped into a predefined shape, such as near-rectangular super patches, essentially reducing the problem to bin-packing. Based on the near-rectangular super patches, a joint optimization is employed to further improve the packing ratio. In order to efficiently deal with large problem instances (or large packing instances) with hundreds of patches, deep neural policies can be trained to predict nearly rectangular patch subsets and determine relative poses between the subsets, which can lead to a linear time scaling with the number of patches. In the disclosure, effectiveness of the provided method was demonstrated on 3 datasets for UV packing, and the provided method shows a higher packing ratio over several widely used related examples with a competitive computational speed.

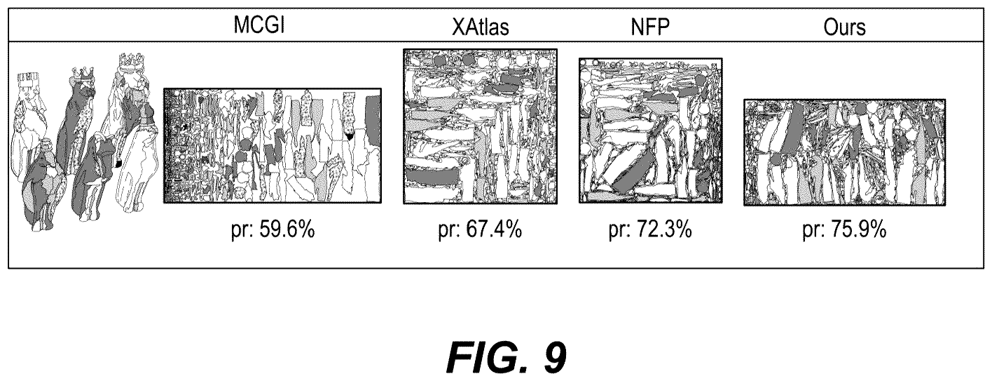

Given a set of UV patches, algorithms of the provided method can find a position and an orientation for each patch. Accordingly, patches may not be collided, and a bounding box of the patches can be minimized. Exemplary bounding boxes in which the patches are packed in can be shown in FIG. 9.

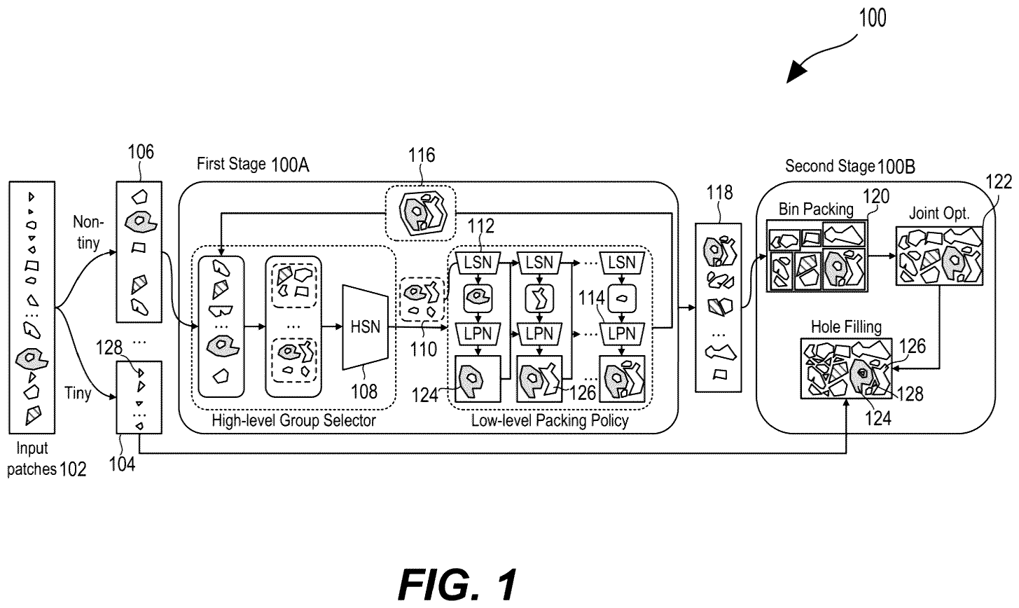

In the disclosure, the provided method can take a set of UV patches as an input. Each patch can be represented, for example, as an irregular, planar, and manifold triangular mesh in a local frame of a reference. An arbitrary number of holes within each UV patch can be allowed. An output of the algorithm of the provided method can be a set of rigid transformations. Each rigid transformation can correspond to a respective patch. Thus, after being transformed, the UV patches can be tightly packed into a rectangular texture domain in a global frame of the reference and in a collision-free manner. A pipeline of the provided method can be illustrated in FIG. 1.

As shown in FIG. 1, a pipeline (100) can start by filtering input patches (102) into separate sets of patches, such as a primary set and a secondary set. The filtering may separate the input patches (102) into a plurality of sets based on size, such as using one or more size thresholds. In an example, the filtering input patches (102) separates the input patches into a tiny (or secondary) set (104) and a non-tiny (or primary) set (106), where the non-tiny set (106) can be processed in two steps in a first stage (100A). The tiny and non-tiny patches may be determined according to a predefined size threshold. In an example, the predefined size threshold can be a pixel value between 1 pixel and 5 pixels.

In the first stage (100A), a first step can iteratively query a high-level group selector network (HSN) (108) to generate a subset of patches, such as a subset (110). A second step then queries a low-level sorter network (LSN) (112) to determine an order of patches to be packed within a subset. For example, a packing order for the patches in the subset (110) can be determined by the LSN (112). The patches in the subset can be forwarded according to the determined order to a low-level pose network (LPN) (114) to determine a pose of each patch. These two steps can group the subset of patches, such as the subset (110), into a super-patch with a pre-defined shape. In an example, the subset (110) can be grouped into a nearly rectangular super-patch (116), which can again be inserted back into the non-tiny set (106). The first and second steps can be repeated to hierarchically group patches in the non-tiny set (106). After the first stage (100A), patches in the non-tiny set (106) can be grouped into super-patches with the predefined shape. In an example, the non-tiny set (106) can be grouped into nearly rectangular super-patches (118). In the second stage (100B), algorithms, such as heuristic bin-packing algorithms, can be applied to assemble all the super-patches (118) into a first bounding box (120). An optimization, such as a joint optimization, can be applied to locally squeeze the patches in the first bounding box (120). For example, spacings of the patches can be squeezed to a predefined value. As shown in FIG. 1, the patches (or non-tiny patches) in the first bounding box (120) can be squeezed into a second bounding box (122) that is smaller than the first bounding box (120). Finally, gaps between non-tiny patches in the second bounding box (122) can be filled using tiny patches from the tiny set (104). For example, as shown in FIG. 1, a tiny patch (128) can be filled in a spacing between the non-tiny patch (124) and the non-tiny patch (126).

In the disclosure, given a set of UV patches, such as the input patches (102), tiny patches (e.g., patch (128)) can be filtered out firstly and the non-tiny patches (e.g., patch (124)) can be processed in two stages (e.g., (100A) and (100B)). The first stage (e.g., (100A)) can aim to turn the non-tiny patches (e.g., subset (110)) into nearly rectangular super-patches. A set [symbol] of super-patches can be generated based on the non-tiny patches. A sampling-based HSN, such as the HSN (108), can be applied to identify a potential subset [symbol] ′ of at most H patches (e.g., H is equal to 4) that can form a nearly rectangular super-patch. An exemplary subset [symbol] ′ can be the subset (110) shown in FIG. 1. To compute the super-patch, a LSN, such as LSN (112), and an LPN, such as LPN (114), can be utilized. The LSN can reorder patches within the subset [symbol] ′ (e.g., subset (110)) and sequentially outputs a to-be-packed patch (e.g., patch (124)) to the LPN. The LPN can select a rough initial pose for each incoming patch, such as the non-tiny patches (124) and (126). An ultimate pose of each incoming patch can be adjusted using a local numerical optimization. Reordering and adjusting the patches in the subset [symbol] ′ based on the LSN and LPN can be denoted as a low-level function LL( [symbol] ′). According to the low-level function LL( [symbol] ′), patches in the subset [symbol] ′can be packed into a super-patch (e.g., super-patch (116)) in which the patches are included in a nearly rectangular-shaped bounding box. Once a super-patch (e.g., super-patch (116)) is generated, the super-patch, which can be denoted as LL( [symbol] ′), can be inserted back into the non-tiny set [symbol] (e.g., set (106)) to replace the subset [symbol] ′ of patches, essentially updating [symbol] as [symbol] − [symbol] ′∪{LL( [symbol] ′)}. In an example, the determined super-patch can still remain in subsequent iteration steps for grouping the patches into the super-patches. In an example, the determined super-patch can be packed with other patches to form a new super-patch.

The process described above in the first stage (100A) can be repeated until each patch (or super-patch) in the non-tiny set [symbol] is packed in a predefined shape, such as in a nearly rectangular shape. As shown in FIG. 1, a plurality of super-patches (118) can be formed based on the HSN (108), the LSN (112), and the LPN (114). In the second stage (100B), all the super-patches can further be assembled using a heuristic bin-packing algorithm. A joint local optimization can then be performed to squeeze all the patches (or super-patches) as tightly as possible. The tiny patches (e.g., (124)) filtered out in the beginning can be put into gaps between non-tiny patches.

In the disclosure, although high-level selector networks (e.g., HSN) are applied before low-level policies (e.g., LSN and LPN), the low-level policies can be trained first due to data dependency. The provided method of the disclosure can be described in an order of training.

Given a subset of H patches that are selected by HSN (e.g., HSN (108)), first i−1 patches that have been packed can be denoted as a super-patch Pᵢ₋₁ in a global frame, and pᵢ can be denoted as a geometric domain of a i-th patch in a local frame. Given pᵢ and Pᵢ₋₁, a low-level packing algorithm needs to select a translation tᵢ and a rotation θᵢ for pᵢ such that the packed shape Pᵢ [symbol] [R(θᵢ)pᵢ+tᵢ]∪Pᵢ₋₁ is collision-free with a high packing ratio. Related packing algorithms may consider each patch independently and evenly sample K rotations and consider possible translations under each rotation using the NFP algorithm. The related packing algorithms can lead to at least [symbol] (KN\hat{ }2) complexity with N being a total number of edges in pᵢ and Pᵢ₋₁, which can be a major bottleneck of packing algorithms. Due to a myopic nature of the related packing algorithms, a packing ratio of the related packing algorithms can be sub-optimal.

To address the shortcomings of the related packing algorithms, the packing procedure of the disclosure, in some aspects, can be modeled as a Markov Decision Process (MDP) and the LPN can be trained to maximize the packing ratio via a reinforcement learning. The LPN (e.g., LPN (114)) provided in the disclosure can identify not only a current patch but also future incoming patches, and exhibit a small optimality gap. Briefly, the MDP can be identified with a tuple <S, A, τ, r>, which can model a procedure of a decision-maker iteratively by observing a current system state in a state space S and taking an action in an action space A to change an environment (or a state) of the state space S. The state of the state space S can then be updated via a state transition function t and the decision-maker can receive a reward r. For a packing problem, however, the action space may involve all possible patch translations and rotations, which can be difficult to handle for the reinforcement learning. Therefore, in the provided method of the disclosure, the action space can be restricted to a small discrete subset, and then a local optimization can be applied to fine-tune a final pose of each patch.

During an i-th iteration of the packing process in which a i-th patch pᵢ can be packed to already-packed patches Pᵢ₋₁, the LPN can observe (or identify) the current system state sᵢ in the state space S. In the disclosure, LPN can observe the current packed patch Pᵢ₋₁ and a set of at most H future patches to be packed. The at most H to-be-packed patches can be denoted as pᵢ, . . . , p_{i+H-1}, for example. Accordingly, the current system state sᵢ can be denoted as sᵢ [symbol] (Pᵢ₋₁, pᵢ, . . . , p_{i+H-1}). The current system state sᵢ includes both the i-th patch pᵢ and the future patches pᵢ₊₁, . . . p_{i+H-1} because the further patches can affect the pose of the current patch in order to achieve joint optimality.

Unlike the myopic algorithms in the related examples that may only consider a single future patch pᵢ, in the disclosure, an entire ordered sequence of H future patches, such as patches pᵢ, pᵢ₊₁, . . . , and p_{i+H-1}, can be fed to the LPN network. By feeding the entire ordered sequence of H future patches to the LPN network, the LPN network can be guided effectively to avoid myopic local minima.

In an aspect, each patch can have an arbitrary geometric shape. Therefore, each patch in the current system state sᵢ (including Pᵢ₋₁) can be rasterized to a 50×50 2D image. For each patch, a center-of-mass (COM) can be moved to an image center. Further, each patch can be encoded using a shared Fully Convolutional Network (FCN) into a 432-dimensional latent code. The FCN can be configured to generalize representative properties (or features) of a patch. Thus, a feature of a patch pᵢ can be denoted as p̅ᵢ [symbol] FCN(pᵢ). The features of the current system state sᵢ can be denoted as s̅ᵢ=FCN(sᵢ) for short. Since patches may be of drastically different sizes, the patches can therefore be scaled before using the FCN. For example, the area of each of the H patches can be scaled as 60% of the area of the 2D image of the H patches. Note that such a global scaling may not change the packing ratio. Accordingly, the global scaling may not change the optimal packing policy. When patches are not enough to fill up the H channels of patches, the FCN can be fed with blank images.

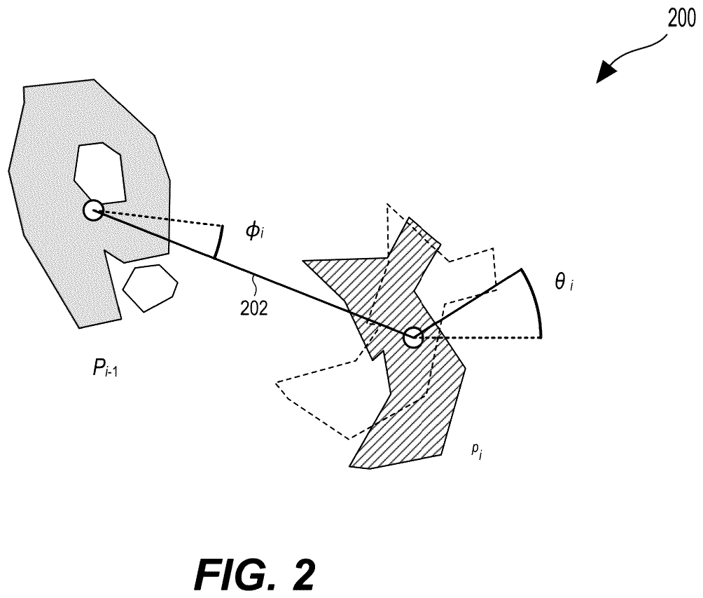

FIG. 2 is schematic illustration of an action space (200). As shown in FIG. 2, given the already packed patch Pᵢ₋₁ and the current patch pᵢ, in order to pack the current patch pᵢ to the already packed patch Pᵢ₋₁, an action from the action space needs to determine a rough rotation θᵢ of pᵢ from a local frame to a global frame, as well as a relative rotation ϕᵢ with respect to Pᵢ₋₁. In an example, the action space (200) can be denoted as aᵢ [symbol] (θᵢ,ϕᵢ) in which both the θᵢ and the ϕᵢ can have 16 candidate angles. Thus, the action space (200) can be a 16×16=256-dimensional discrete action space and correspond to 256 candidate actions to pack the current patch pᵢ to the already packed patch Pᵢ₋₁.

Having observed sᵢ, the LPN can be represented as a policy function aᵢ=π^{LPN}(sᵢ) that maps a state sᵢin the state space S to an action aᵢ in the action space A. The policy function indicates a probability distribution assigned to the set of actions in the action space. Unlike related works for learning-based regular shape packing or shape ordering, an action space A for irregular packing can be much more challenging. On one hand, a valid action space may only include actions associated with collision-free patch poses. However, identifying these actions can involve extensive collision checks. On the other hand, training a decision-maker in a high-dimensional action space can be data-demanding. Thus, a promising subset of actions may be pre-selected.

To tackle the two problems described above, the policy π^{LPN} in the policy function aᵢ=π^{LPN}(sᵢ) can be set to select a rough initial guess of a pose of a patch and then use a local optimization to revise the pose. For example, the action space A can be re-parameterized under polar coordinates, such as the polar coordinates in FIG. 2. The COMs for Pᵢ₋₁ and pᵢ, can be computed and denoted as COM(Pᵢ₋₁) and COM(pᵢ) respectively. The relative position COM(pᵢ) with respect to COM(Pᵢ₋₁) can be expressed under the polar coordinates with the relative angle ϕᵢ and relative distances between the COM(pᵢ) and COM(Pᵢ₋₁) can be ignored. Similarly, a local-to-global rotation of pᵢ can be encoded as another angle θᵢ. In summary, the action space of the disclosure can be defined as aᵢ [symbol] (θᵢ,ϕᵢ) in which both a range of θᵢ and a range of ϕᵢ can be sampled at 16 angles. Thus, the action space can be considered as a 16×16=256-dimensional discrete action space.

In the disclosure, a state transition function sᵢ₊₁=τ(sᵢ,aᵢ) can compute a next state sᵢ₊₁ from sᵢ and aᵢ by converting the action θᵢ and ϕᵢ into a collision-free and tightly packed pose. Since a coarse discretization of the action space is applied in the disclosure, the state transition function can be further used to locally revise the action and improve the packing ratio. In an example, a collision-constrained local optimization can be devised as follows in equations (1) and (2):

$${θ}_{i}^{*} , {t}_{i}^{*} arg {min}_{θ , t} ‖ R ( θ ) C O M ( {p}_{i} ) + t - C O M ( {P}_{i - 1} ) {‖}^{2} \qquad Eq . ( 1 )$$

$$s . t . [ R ( θ ) {p}_{i} + t ] ∩ {P}_{i - 1} = ∅ \qquad Eq . ( 2 )$$

where θᵢ can be initialized as θ and tᵢ can be initialized from ϕᵢ by elongating a relative direction (e.g., direction (202) in FIG. 2) between Pᵢ₋₁ and pᵢ until Pᵢ₋₁ and pᵢ are collision free. The next state sᵢ₊₁ can be updated as sᵢ₊₁ [symbol] ([R(θ)pᵢ+t]∪Pᵢ₋₁, pᵢ₊₁, . . . , p_{i+H}). It should be noted that, in the disclosure, a distance between a center-of-mass of Pᵢ₋₁ and a center-of-mass of pᵢ can be used as a surrogate measure for the packing ratio. Thus, the packing ratio may not be chosen as an objective function because the new patch pᵢ can oftentimes be entirely contained in a bounding box of Pᵢ₋₁ and all the poses of pᵢ inside the bounding box can have a same packing ratio. The collision constraint shown in equations (1) and (2) can be realized in several ways, including a scaffold method and a boundary barrier energy. In the disclosure, the boundary barrier energy is adopted, in some aspects, because the boundary barrier energy can avoid costly 2D re-meshing. Although the scaffold method may have better solutions in large-scale problems, the barrier energy technique can perform better, for example, under small problem sizes with only 3 decision variables. The optimization in equations (1) and (2) can be solved using Newton's method with a line-search to guarantee constraint satisfaction. During the line-search, a bounding volume hierarchy can be implemented to accelerate the collision check and assembly of barrier energy terms.

To train the LPN, π^{LPN} can be parameterized as an MLP (Multilayer perceptron) mapping s̅ᵢ (e.g., s̅ᵢ=FCN(sᵢ)) to Q-values of all 256 actions in the action space A. The MLP can be a neural network that includes an input layer and an output layer, and one or more hidden layers with stacked neurons. After each state transition, the policy (or LPN policy) can receive a sparse reward signal defined in equation (3) as follows:

$$r ( {s}_{i} , {a}_{i} , {s}_{i + 1} ) = p r ( {P}_{i} ) I [ i = H ] \qquad Eq . ( 3 )$$

where pr(P) can be a packing ratio of a super-patch P and I[i=H] is an indicator function of a last iteration (e.g., indication of a last patch being packed). Note that using sparse reward signals shown in equation (3) can significantly slow down policy learning. However, in the disclosure, the reward signals may not pose a major problem because a short horizon H, such as |H|<5, is applied. The LPN policy can be trained via a Q-learning algorithm by maximizing an expected cumulative reward shown in equation (4):

$$arg {max}_{{π}^{L P N}} {E}_{{a}_{i} \sim {π}^{L P N}} [ {\sum }_{i = 1}^{H} r ( {s}_{i} , {a}_{i} , {s}_{i + 1} ) ] \qquad Eq . ( 4 )$$

where aᵢ=π^{LPN}(sᵢ), π^{LPN} indicates a probability of action aᵢ that is selected from the action space (e.g., the action space can include 16×16=256 candidate actions) to apply on the patch pᵢ. The action aᵢ can result in the corresponding reward: r(sᵢ, aᵢ, sᵢ₊₁). To solve the stochastic optimization shown in equation (4), a double deep Q-learning (DDQN) algorithm can be applied and π^{LPN} can be trained to pack randomly sampled batches of at most H patches in an arbitrary order from a patch dataset, where each sampled batch can come from the same 3D model.

In the disclosure, the LSN can provide an optimal patch ordering for the LPN to achieve a best (or a largest) packing ratio, as the LPN may only pack patches in a given order. For example, as shown in FIG. 1, the LSN (112) can determine a packing order of the patches in the subset (110) for the LPN (114) to operate the patch packing. The patch sorting procedure can be modeled as another MDP denoted as <S,A′,τ′,r >with a same state space S and a same reward signal r as that of LPN. The LSN can be represented as another policy function a′ᵢ=π^{LSN}(sᵢ) that can select a next patch to be packed. In an example, a′ᵢ can include Q-values of k future patches. Given a selected next patch, such as the patch pᵢ, a state transition function τ′(sᵢ,a′ᵢ) can invoke the LSN yield an updated sate sᵢ₊₁, such as sᵢ₊₁=τ(sᵢ,aᵢ′).

Neural networks need to understand a relative relationship between the future patches to accomplish the sorting task. Therefore, a Graph Attention Network (GAT) module can be applied. The GAT is configured to convert features (e.g., node features) of the patches into high-level graph features and is effective in solving sorting tasks. In an example, all the patches (e.g., the already packed patches Pᵢ₋₁ and the current patch pᵢ) can be organized into a fully connected graph, where a nodal input of GAT can be a feature (e.g., p̅ᵢ) of a to-be-packed patch (e.g., pᵢ) along a feature P̅ᵢ₋₁ of the already packed super-patch Pᵢ₋₁. GAT can output a high-level graph feature for each of the existing patches (e.g., Pᵢ₋₁ and pᵢ). The graph feature of each patch can then be converted to a respective Q-value via an MLP. A sorting policy, denoted as π^{LSN}, can be parameterized. Similar to π^{LPN}, π^{LSN} can be trained using DDQN via randomly sampled batches of at most H patches coming from the same 3D model. The LSN and LPN combined define a low-level function LL( [symbol] ′). The low-level function LL( [symbol] ′) indicates that patches in a subset [symbol] ′ are packed into a super-patch that has a nearly rectangular shape.

In the disclosure, low-level policies, such as the LSN and LPN, may only sort and pack a small subset [symbol] ′ of H patches (e.g., H=4 patches). In order to solve practical UV packing problems with hundreds of patches, subsets [symbol] ′ may need to be iteratively selected from the non-tiny set S. Therefore, a weighted average packing ratio pr(⋅) can be applied to evaluate a quality of an updated configuration pr( [symbol] − [symbol] ′∪LL( [symbol] ′)) and a subset [symbol] ′ can be picked up, such as the subset [symbol] ′ corresponding to a highest ratio. The HSN can then be trained to rank the quality (e.g., pr(⋅)) of the subsets [symbol] ′ without actually employing the costly low-level function LL( [symbol] ′). Finally, a sampling strategy can be applied to further reduce the employments of the HSN.

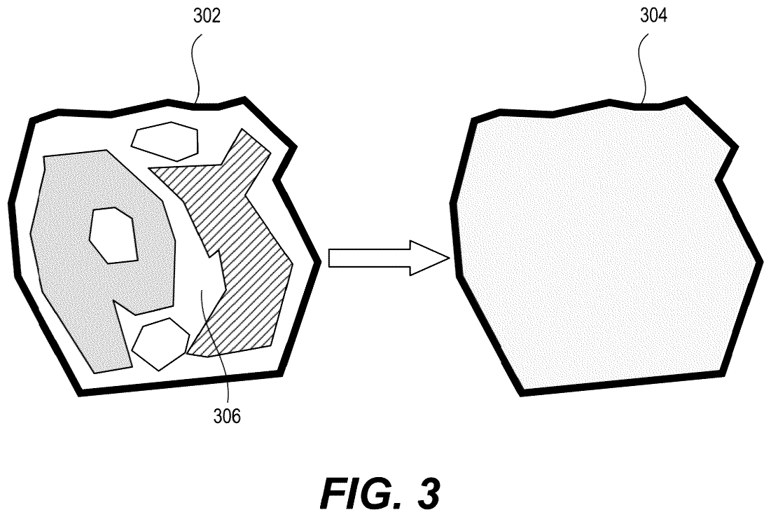

In order to compare different choices of subsets [symbol] ′, a metric, such as the area-averaged packing ratio, that measures similarity of the subsets [symbol] ′ to rectangles can be defined. In an example, the area-averaged packing ratio over all the super-patches P in non-tiny set [symbol] can be defined as follows in equations (5) and (6).

$$pr ( ) \frac{{Σ}_{p ∈ S} area ( p ) p r ( p )}{{Σ}_{p ∈} \vert bound ( p ) \vert} \qquad Eq . ( 5 )$$

$$pr ( p ) \frac{area ( p )}{\vert bound ( p ) \vert} \qquad Eq . ( 6 )$$

where area(p) and bound(p) can be an actual area and a bounding box of a super-patch p, respectively. In an aspect, the high geometric complexity of the super-patches can be due to interior gaps between the super-patches. However, these interior gaps may not be utilized for low-level packing policies. For example, as shown in FIG. 3, gaps in the already packed patches Pᵢ₋₁ may not affect the new patch pᵢ to be packed form the outside of Pᵢ₋₁. Therefore, before inserting LL( [symbol] ′) to [symbol] , an alpha shape for each new super-patch can be defined. The alpha shape can be defined to fill up interior gaps of the new super-patch and the neural networks can be informed that interior gaps are useless by design.

FIG. 3 shows an exemplary alpha shape (304) of a super-patch (302). As shown in FIG. 3, interior gaps, such (306), in the super-patch (302) can be filled up to form the alpha shape (304).

Exhaustively evaluating pr(⋅) for all C_{|} [symbol] _{|}^{H} choices of [symbol] ′ can require an intensive amount of calls to the low-level packing policies (e.g., LSN and LPN) as well as the costly optimizations shown in equations (1) and (2). Therefore, a learning-based technique can be provided to predict a packing ratio using HSN. For a given subset [symbol] ′, the HSN can use the same FCN from the low-level policies (e.g., LSN and LPN) to encode each patch. The latent codes obtained from FCN can be then be brought through the GAT to yield the high-level graph features as in LSN. All the graph features are then brought through a max-pooling layer and a sigmoid layer to yield the predicted packing ratio. Note absolution values of the packing ratio are less important because the predicted packing ratio is merely applied to determine a relative ordering of the potential super-patches. Accordingly, the HSN can be trained via a supervised metric learning. During each learning iteration of the supervised metric learning, two (or less) H-patch groups can be randomly sampled and denoted as [symbol] ′ and [symbol] ″ with ground truth packing ratios denoted as pr′ and pr″ and HSN predicted packing ratios denoted as HSN( [symbol] ′) and HSN( [symbol] ″). The HSN can then be updated via a margin ranking loss shown in equation (7).

$$ℒ = max ( 0 , - sgn ( {pr}^{′} - {pr}^{″} ) ( HSN ( {′}^{} ) - HSN ( {″}^{} ) ) + ϵ ) \qquad Eq . ( 7 )$$

where ∈ a minimal positive margin. The margin ranking loss can check whether the prediction order for pr(s) is correct in the training process. For example, if pr′<pr″, the HSN( [symbol] ′) should be less than HSN( [symbol] ″). Based on the margin ranking loss, it is observed that the HSN can empirically reach a high prediction accuracy for simple patches, but an accuracy of the HSN can gradually deteriorate as more and more patches are packed into complex-shaped super-patches.

Although HSN can be applied to efficiently rank the packing ratios, batch evaluation of pr(⋅) for all [symbol] ′ may still be time-consuming. To further alleviate the runtime cost, a plurality of subsets can be randomly sampled from the non-tiny set. For example, 400 subsets of patches can be randomly sampled (or selected) and packing ratios of the 400 sample subsets can be predicted via a batched HSN evaluation. A top 10 out of the 400 sample subsets can then be forwarded to the low-level algorithm (e.g., LSN and LPN) to evaluate the ground truth packing ratio pr( [symbol] − [symbol] ′∪LL( [symbol] ′)), and finally a best (or the one with the largest packing ratio) of the 10groups can be adopted to form a next super-patch. The selection of super-patch can be repeated until an updated packing ratio pr( [symbol] ) is not higher than a current value of the pr( [symbol] ). The selection of the super-patch can be described by an algorithm in Table 1.

TABLE 1
An algorithm of super-patch selection

| Algorithm 1 Iterative Selection of Super-Patches | |
|---|---|
| 1: | S←non-tiny set |
| 2: | Sample 400 subsets S′_{1,...,400} |
| 3: | Sort S′_{1...,400} in HSN(S′ᵢ)-descending order |
| 4: | Sort S′_{1,...,10} in pr(S − S′ᵢ ∪ LL(S′ᵢ))-descending order |
| 5: | If pr(S − S′₁ ∪ LL(S′₁)) > pr(S) then |
| 6: | S← S − S′₁ ∪ LL(S′₁), go to Line 2 |
| 7: | else Return S |

As show in Table 1, the algorithm can start with step 1, where a non-tiny set can be defined as S. At step 2, 400 subsets S′_{1, . . . 400} can be sampled from the non-tiny set S. At step 3, predicted packing ratios HSN(S′ᵢ) for the 400 sample subsets can be determined based on the HSN. The 400 sample subsets can further be sorted based on the predicted packing ratios in a predefined order, such as a descending order. At step 4, top 10 subsets that correspond to 10 highest predicted packing ratios can be selected from the 400 sample subsets. Patches in each of the top 10 subsets S′_{1, . . . 10} can further be packed based on the LSN and LPN. A ground truth packing ratio pr(S−S′ᵢ∪LL(S′ᵢ)) can be determined accordingly for each of the packed top 10subsets LL(S′ᵢ). Further, a subset S′₁ can be selected from the top 10 subsets. The subset S′₁ can correspond to a largest ground truth packing ratio pr(S−S′₁∪LL(S′₁)). At step 5, if the updated ground truth packing ratio pr(S−S′₁∪LL(S′₁)) associated with the selected subset S′₁ is larger than the current ground truth packing ratio pr(S), the algorithm proceeds to step 6, where the super-patch (e.g., LL(S′₁)) is inserted in the subset S to replace the subset S′₁, and the iteration goes back to step 2. If the updated ground truth packing ratio pr(S−S′₁∪LL(S′₁)) associated with the selected subset S′₁ is less than the current ground truth packing ratio pr(S), the iteration of selection can be terminated.

After the first stage, such as the first stage (100A) in FIG. 1, the non-tiny patches can be grouped into nearly rectangular super-patches. During the second stage (e.g., (100B)), the super-patches with a rectangular shape can be assembled using a divide-and-conquer algorithm implemented in a mesh processing library, such as a Trimesh library. The Trimesh library can include a set of utilities for reading, writing, and manipulating 3D triangle meshes. The super-patches can be assembled in a bounding box, such as the bounding box (120) in FIG. 1.

When the super-patches are assembled based on a bin-packing algorithm, joint poses of all the patches in the super-patches can be adjusted such that the patches can be locally squeezed together via a numerical optimization. For example, a bounding box (e.g., (120)) enclosing all the M patches can be denoted as bound (p₁, . . . , p_{M}), and the numerical optimization can be formulated as follows in equations (8) and (9):

$$arg {min}_{{θ}_{1 , ⋯ , M} , {t}_{1 , ⋯ , M}} \vert bound ( p\_ 1 , ⋯ , p\_M ) \vert \qquad Eq . ( 8 )$$

$$s . t . [ R ( {θ}_{i} ) {p}_{i} + {t}_{i} ] ∩ [ R ( {θ}_{j} ) {p}_{j} + {t}_{j} ] = ∅ ∀ 1 \leq i < j \leq M \qquad Eq . ( 9 )$$

Equation (8) can indicate that a boundary of the bounding box including all the M patches should be minimized, and equation (9) indicates that any two patches in the bounding box should not be overlapped.

Further, a barrier function technique can be applied to solver the equations (8) and (9). Therefore, the collision-free guarantees can be guaranteed, and the bounding box is ensured to surround all the patches. Although the equations (8) and (9) are related to a joint optimization, the equations (8) and (9) are still efficient to be solved because rigid motions are allowed for all the patches.

Finally, the set of tiny patches, such as the tiny set (104), that are set aside by a filter at the beginning of the pipeline (100), can be applied. The small patches in the tiny set can be sorted in an area-descending order and then be fit into gaps and holes of the super-patches. In an example, the small patches can be fit using a scanline algorithm. When the scanline algorithm is applied, the alpha shapes of the super-patches can be replaced with the original patches in the super-patches. The original patches can be exposed to the scanline algorithm such that the scanline algorithm can identify potentially useful gaps and holes.

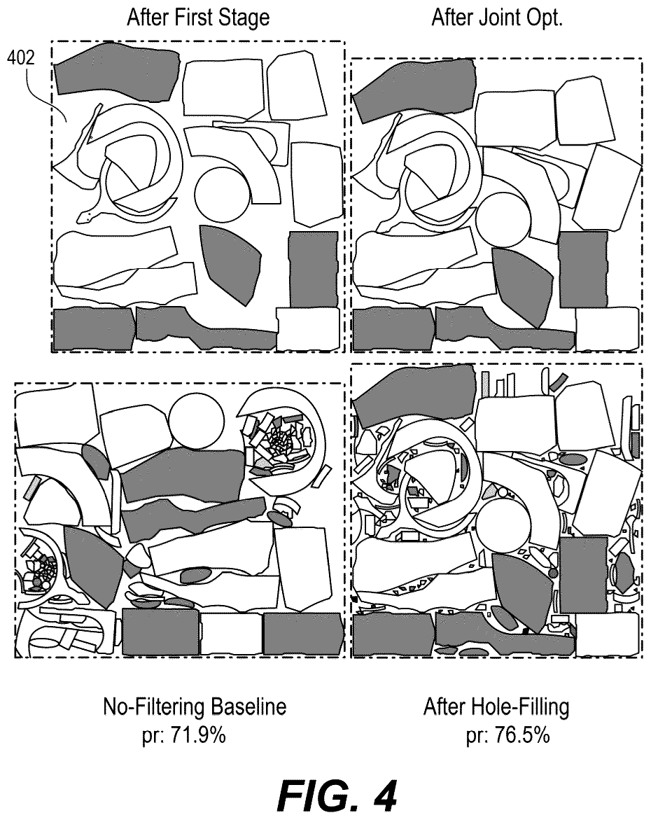

FIG. 4 shows a plurality of input patches are that packed in different stages. As shown in FIG. 4, after the first stage, non-tiny patches of the input patches can be grouped into super-patches. Gaps, such as a gap (402), can exist between non-tiny patches. After a joint optimization, the non-tiny patches can be squeezed, and the gaps can be reduced. After hole-filing, the tiny patches can be fit in the gaps and a packing ratio of 76.5% can be obtained. Still referring to FIG. 4, in a no-filtering baseline, the tiny patches are not filtered out and both the tiny and non-tiny patches are forwarded to HSN, LSN, and LPN for patch packing. Accordingly, a packing ratio of 71.9% can be obtained.

In the disclosure, networks (e.g., HSN, LSN, and LPN) training can be performed. In an example, experiments of training can be performed on a computer with an Intel E5-1650 12-core CPU at 3.60 GHz and 32 GB RAM. Learning algorithms can be implemented via Pytorch. Pytorch can be a machine learning framework based on a Torch library. Based on Pytorch, the GAT can be implemented. For training the LPN, DDQN was applied with an experience buffer size of 10⁶ transition tuples. In an example, roughly 8×10⁴ random packing problems were sampled with H=4 to populate the experience buffer. π^{LPN} was updated using 2×10⁴ epochs of stochastic gradient descend (SGD). A same procedure was applied on training π^{LSN}. Both a learning rate of the LPN and a learning rate of the LSN were set to 10⁻⁴. HSN was trained using a collected dataset of 6×10⁴ H-patch subsets with pre-computed ground truth packing ratios. In an example, HSN was updated using 500 epochs of SGD with a learning rate of 10⁻³ and a batch size of 256. For each dataset, 70% of data was used for training and the rest for testing.

To pack the patches, runtime setting can be defined. Given a set of input patches, the input patches can be sorted in an area-descending order, and then a subset of largest patches can be considered, which can be denoted as salient subset [symbol] [symbol] . In an example, a total area of the subset of largest patches can take up 80% of the area of all patches. An average area of patches in the salient subset can be denoted as ā=Σp∈ [symbol] [symbol] ₐᵣₑₐ(p)/| [symbol] [symbol] |. Next, a tiny patch set was defined as all the patches with an area smaller than ā/5, and patches with an area larger than ā/5 was classified as a non-tiny set. The numerical optimizations in equations (1), (2), (8), and (9) were implemented in C++, where a maximal allowed iterations was set and initial step size to 10³ and 10⁻⁴, respectively. In the super-patch assembly, an aspect ratio between a width and a height of a texture image domain ranged from 1 to 2. To choose an appropriate aspect ratio, a bin-packing algorithms was run 10 times using different aspect ratios and to choose the one with the highest packing ratio.

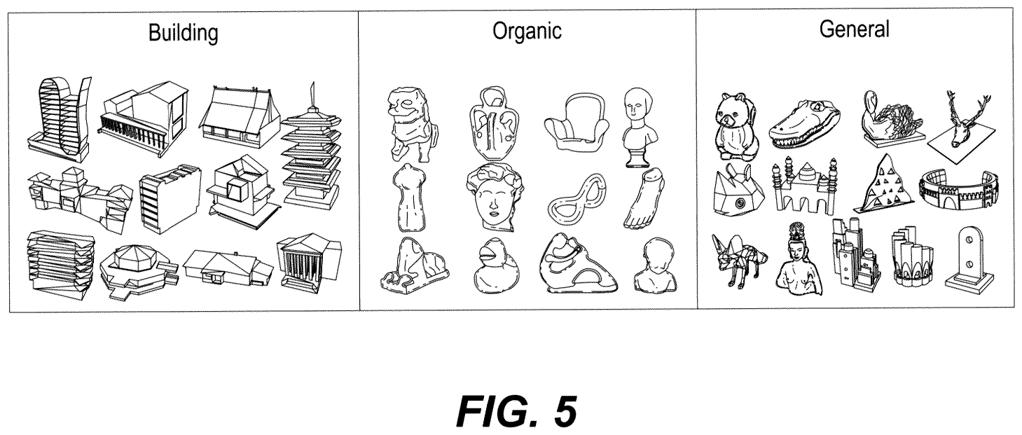

To pack the patches, a dataset was defined. The provided method of the disclosure was evaluated on three datasets of 2D UV patches obtained from UV unwrapping of 3D models using XAtlas. XAtlas sometimes generated degenerate patches with zero or negative areas, which were removed from the dataset. As illustrated in FIG. 5, the datasets include a building dataset. The building dataset contains 86 man-made 3D building models with mostly sharp features. Each of the building models results in 5 to 131 patches. The databases include an organic dataset. The organic database includes 81 3D organic models with few sharp features. Each of the 3D organic model results in 9 to 200 patches. The databases further include a general dataset that includes 221 3D general models from Thingi10k, where each of the 3D general models results in 4 to 200 patches.

In the disclosure, the provided method was compared with three related examples. The first related example is an NFP-based packing approach combining two heuristic methods: a maximal packing ratio and a lowest gravity center. Therefore, the first related example can be denoted as NFP-Heuristic. Given a list of patches, NFP-Heuristic first sorts all patches in an area-descending order and then sequentially packs each patch. For a new patch, NFP-Heuristic considers 16 rotations of the new patch and computes NFP for each rotation using Minkowski sum to find collision-free translations. Finally, a pose leading to a highest packing ratio was selected. If two poses lead to a same packing ratio, the one with a lower gravity center position was selected. The NFP was computed using a highly optimized reduced convolution algorithm implemented in a Computational Geometry Algorithms Library (CGAL). The second related example is a packer algorithm implemented in the open-source software: XAtlas, which implements aggressive simplification and acceleration techniques, allowing the packing algorithm to scale to problems with hundreds or thousands of patches. For example, XAtlas uses voxelized patches instead of piecewise linear ones, so that a scanline algorithm instead of exact NFP computation can be used. The third related example was a method to generate multi-chart geometry images (MCGI) using Python. A major difference between XAtlas and MCGI lies in heuristics, where XAtlas maximizes a packing ratio and MCGI minimizes a wasted area. The comparing results between the provided method and the related examples can be shown in Table 2.

TABLE 2
Comparison between provided method and the related examples

| Test-set | MCGI | | | XAtlas | | | NFP | | |
|---|---|---|---|---|---|---|---|---|---|
| Building | 0.470 | 0.830 | 0.675 | 0.525 | 0.835 | 0.670 | 0.499 | 0.907 | 0.707 |
| Organic | 0.290 | 10.733 | 0.609 | 0.385 | 10.788 | 10.588 | 0.439 | 10.805 | 0.630 |
| General | 0.455 | 0.883 | 0.652 | 0.449 | 0.886 | 0.688 | 0.405 | 0.886 | 0.690 |
| Test-set | Ours | | | Ours* | | | Our^{†} | | |
| Building | 0.683 | 0.980 | 0.827 | 0.683 | 0.980 | 0.801 | 0.683 | 0.980 | 0.805 |
| Organic | 0.377 | 0.862 | 0.687 | 0.377 | 0.843 | 0.680 | 0.377 | 10.862 | 0.682 |
| General | 0.540 | 0.937 | 0.776 | 0.509 | 0.937 | 10.757 | | — | |

As shown in Table 2, packing ratios (Min|Max|Avg) are summarized for the provided method and the related examples. Ours* means the provided algorithm of the disclosure run with a fixed aspect ratio of 1. Ours^{†} means the provided algorithm of the disclosure trained on the general dataset.

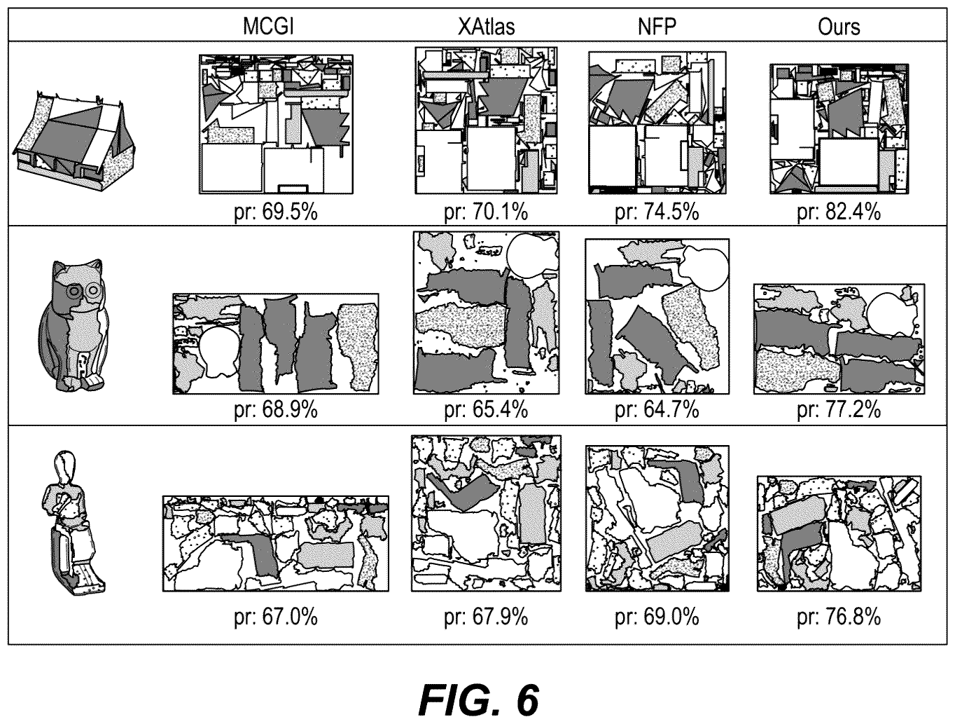

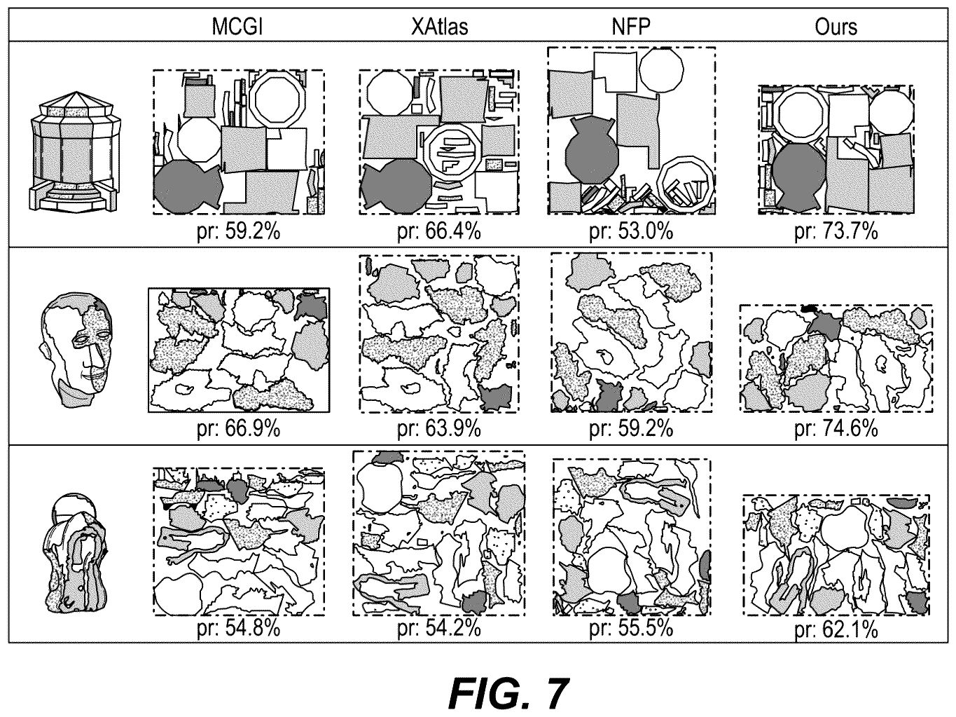

For each dataset, the packing ratios of all the algorithms on the testing problems can be profiled. The profiled packing ratios can be summarized in Table 2. As shown in Table 2, the provided algorithm of the disclosure consistently outperforms the related examples by 5%-10%. To further justify generality of the provided method, the networks (e.g., HSN, LPN, and LSN) of the provided method were trained on the general dataset (Ours^{†}) but tested on the other two datasets. Test data shows that the provided method suffers from a marginal loss in packing ratio, but still outperforms the related examples. The test data justifies that the provided method has a reasonable ability of domain transfer and can be ported to pack patches for different classes of 3D models in a zero-shot fashion. More comparison results between the provided method and the related examples are illustrated in FIGS. 6 and 7.

In the disclosure, ablation study was further performed. For example, aspects of the learning-assisted technique in the provide method were analyzed. First, the accuracy of HSN was profiled, which was measured by a fraction of patch pairs that are correctly ranked. HSN in the provide method achieves an accuracy of 90.8%, 86.9%, and 84.6% on the building, organic, and general test sets, respectively. The trained HSN of the disclosure achieves a high-ranking accuracy for the building dataset and the accuracy degrades for the organic and general datasets, in which the patch shapes are more complex than those in the building dataset. Next, the packing ratio of the low-level π^{LPN} and π^{LSN} in the provided method was highlighted (or evaluated) separately. In an example, a random subset of H patches was sampled and the LL in the provided method was applied for patch packing. LL of the disclosure was compared with the related examples and the results averaged over 2500 random problems were summarized in Table 3. As shown in Table 3, the deep reinforcement learning (DRL)-based packing policy in the provided method still outperforms the related examples for smaller packing problems with H patches, which validates the necessity of using a learned packing policy as the low-level packer.

Further, the packing ratio of LL under different horizons H was also compared. For example, four low-level algorithms were trained with H=2, . . . , 5 and packing ratios over the 2500 random problems were found to change from 74.1%, 77.1%, 77.6%, to 77.0%, respectively. The provided method performs the worst when H=2, where the low-level policies of the provided method become myopic, but the quality varies only slightly when H≥2. Therefore, H=4 was chosen in the provide method for the highest quality. Finally, two variants of the provided method were analyzed. In a first variant (NFP+HSN), LL(⋅) was replaced with NFP and an area-descending ordering, but still use the HSN of the provided method for hierarchical grouping. In a second variant (LPN+LSN+HSN), the low- and high-level algorithms of the provided method were used but without hole-filling. Thus, all the patches (e.g., the tiny and non-tiny patches) were considered in the high-level algorithm and the tiny patches were not filtered. As summarized in Table 4, the provided method achieves a best packing ratio, justifying the effectiveness of the low-, high-level algorithm, and the hole-filing procedures of the provided method.

Table 3 shows an average packing ratio comparison between the LL of the provided method and the related examples over 2500 random problems with H patches. Table 4 shows a packing ratio comparison of algorithm variants based on the general dataset.

TABLE 3
An average packing ratio comparison

| | MCGI | XAtlas | NFP | Ours (LL) |
|---|---|---|---|---|
| pr | 0.618 | 0.651 | 0.582 | 0.686 |

TABLE 4
A packing ratio comparison of algorithm variants

| | NFP | NFP + HSN | LPN + LSN + HSN | Ours |
|---|---|---|---|---|
| pr | 0.690 | 0.700 | 0.744 | 0.776 |

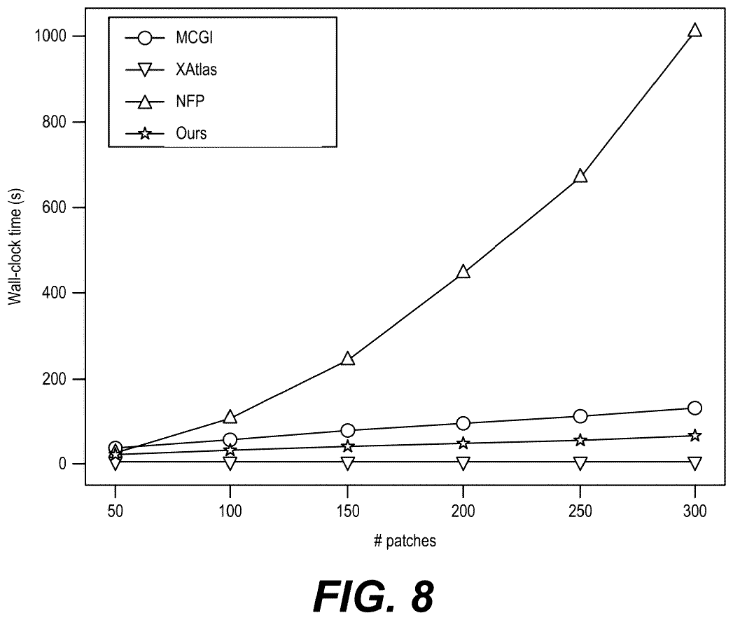

In the disclosure, a computational cost comparison was performed. Although the provided method achieves better packing ratios, a computational efficacy of the provided method may be less than XAtlas, due to the repeated network evaluation. For the general dataset, the average packing time of XAtlas, MCGI, NFP, and the provided method are 1.81 s, 33.52 s, 93.62 s, and 37.76 s, respectively. The performance breakdown for the provided method on the general dataset can be summarized in Table 5. As shown in Table 5, a computational bottleneck lies in the scanline-based hole filling, which involves nested loops and is implemented in Python. The provided method can be accelerated, for example if a scanline algorithm is implemented in native-C++. The scalability of the provided method was evaluated in dealing with large UV packing problems. For example, patches from several 3D models were combined and each algorithm in the provided method was used to pack all the patches into a single texture. A dataset including packing instances with 50, 100, 150, 200, 250, and 300 patches was created. The provided method and the related examples were further performed on the created database. A computational overhead is plotted against the number of patches in FIG. 8. As shown in FIG. 8, the cost of NFP is much higher than other algorithms due to the superlinear increase of computational complexity in computing the Minkowski sum. By introducing the high-level selection policy, the provided method can scale linearly against the number of patches, although the provided method may be slower than XAtlas. In FIG. 9, a comparison example is shown in which 784 charts segmented from 6 animal chesses are packed into a single Atlas. The packing time of MCGI, XAtlas, NFP, and the provided method are 180.68 s, 4.68 s, 2966.63 s and 278.87 s, respectively. Thus, the provided method may achieve a better packing ratio than NFP while requiring significantly fewer computational resources.

TABLE 5
Performance breakdown for the provide
method on the general dataset

| Procedure | Cost(%) |
|---|---|
| HSN Evaluation | 10.1% |
| LPN + LSN Evaluation | 18.4% |
| Bin-packing | 3.9% |
| Joint optimization | 12.9% |
| Scanline-based hole filling | 52.9% |

In the disclosure, a user-controlled aspect ratio was evaluated. By default, an optimal aspect ratio of the texture image was searched to maximize the packing ratio. However, the provided method may be easily adapted to support a user-specified packing ratio, by forwarding the user-specified packing ratio to the bin-packing procedure. To compare the provide method with XAtlas, experiments were conducted by specifying the aspect ratio as 1.The results of these experiments are also summarized in Table 2 which is labelled as Ours*. As shown in Table 2, the provided method (Ours*) can still generate the best results compared to the related examples, although in some cases with an expected degradation compared to the results with the default setting.

In the disclosure, a learning-assisted shape packing algorithm is provided for UV patches, the shape packing may be performed on one or more irregular shapes. On three datasets with various topology and geometry properties, the provided algorithm can achieve 5%-10% packing ratio improvement over algorithms provided by XAtlas, NFP, and MCGI. The provided algorithm can deal with problem instances (or packing instances) with up to hundreds of patches within a tolerable computational overhead for offline packing. By optimizing rigid transformations for the patches, the provided method respects the input UV patch shapes and parameterizations, which can be immediately incorporated into existing UV unwrapping pipelines.

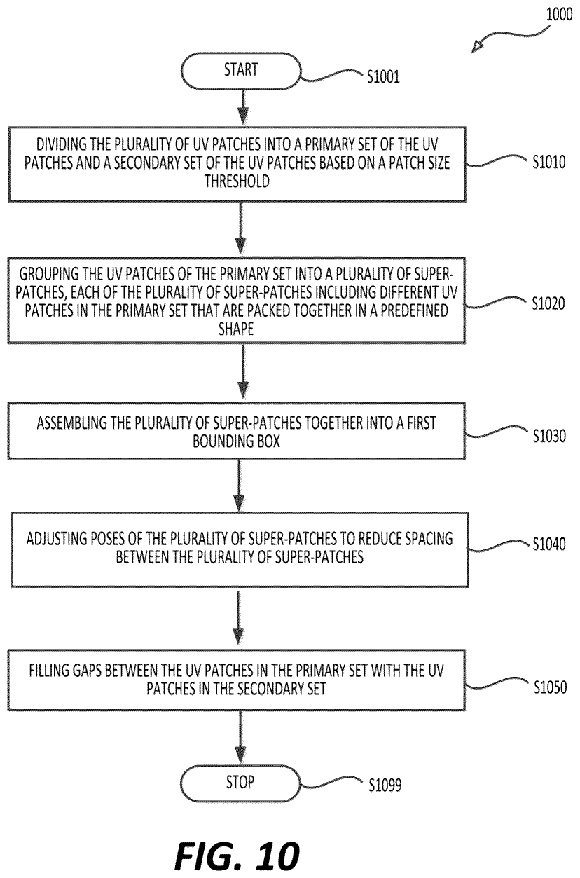

FIG. 10 shows a flow chart outlining a process (1000) for sound simulation according to an embodiment of the disclosure. The process starts at (S1001) and proceeds to (S1010).

At (S1010), the plurality of UV patches is divided into a primary set of the UV patches and a secondary set of the UV patches based on a patch size threshold. For example, as shown in FIG. 1, the input patches (102) can be filtered into a primary set (or non-tiny set) (106) and a secondary set (or tiny set) (104). In an example, the patch size threshold is ā/5. ā is an average area of patches in a salient subset and is denoted as ā=Σp∈ [symbol] [symbol] ₐᵣₑₐ(p)/| [symbol] [symbol] |.

At (S1020), the UV patches of the primary set are grouped into a plurality of super-patches. Each of the plurality of super-patches includes different UV patches in the primary set that are packed together in a predefined shape. An exemplary embodiment of step (S1020) is shown in FIG. 1, where the UV patches of the non-tiny set (106) are grouped into a plurality of super-patches (118) based on the HSN, LSN, and LPN.

At (S1030), the plurality of super-patches is assembled together into a first bounding box. For example, as shown in FIG. 1, the plurality of super patches (108) is assembled into a bounding box (120) based on a heuristic bin-packing algorithm.

At (S1040), poses of the plurality of super-patches are adjusted to reduce spacing between the plurality of super-patches. In an example. As shown in FIG. 1, the poses of the patches in the first bounding box (120) are adjusted based on the joint optimization. Accordingly, the spacing between the plurality of super-patches are reduced.

At (S1050), gaps between the UV patches in the primary set are filled with the UV patches in the secondary set. For example, as shown in FIG. 1, the tiny patches, such as patch (128), are filled in the gaps between the UV patches in the non-tiny set.

In an example, based on a HSN configured to identify a subset from the primary set to from a super-patch of the plurality of super-patches, M subsets are selected from the primary set. Each of the M subsets includes respective N UV patches, where the M is a first positive integer, and the N is a second positive integer smaller than M. An estimated area-averaged packing ratio associated with each of the M subsets is determined. The M subsets is reordered based on the estimated area-averaged packing ratios. L subsets are determined from the M subsets that correspond to L largest estimated area-averaged packing ratios.

In an example, the UV patches in each of the L subsets are packed together into a respective subset bounding box. An area-averaged packing ratio associated with each of the packed L subsets is determined. A first super-patch of the plurality of super-patches is determined from the packed L subsets. The first super-patch corresponds to a largest area-averaged packing ratio among the determined area-averaged packing ratios of the packed L subsets.

In an aspect, the UV patches in a first subset of the L subsets is packed into a first subset bounding box. For example, based on a LSN that is configured to determine a packing order of the UV patches in the first subset, the UV patches in the first subset are organized into a connected graph in which already-packed patches and to-be-packed patches of the first subset are connected to each other. Node features of the UV patches in the first subset are input into a GAT to obtain graph features of the UV patches of the first subset. The graph features are converted to corresponding Q-values via a MLP that includes an input layer and an output layer, and one or more hidden layers with stacked neurons. A first one of the to-be-packed patches is determined to pack to the already-packed patches based on the Q-values.

In an example, the node features of the UV patches of the first subset are determined based on a FCN in which the UV patches of the first subset are encoded into a F-dimensional latent space, where the F is a positive integer.

In an aspect, based on a LPN that is configured to determine a pose of a UV patch in the primary set, a state space is determined. The state space indicates position states of the already-packed patches and the to-be-packed patches in the first subset. An action space for the to-be-packed patches is determined. The action space indicates candidate packing actions for the to-be-packed patches. Each of the candidate packing actions in the action space is applied on the first one of the to-be-packed patches. An updated state space corresponding to each of the candidate packing actions that is applied on the first one of the to-be-packed patches is determined. A reward value corresponding to each of the updated state spaces associated with the first one of the to-be-packed patches is determined. Each of the reward values corresponds to an area-average packing ratio associated with the respective candidate packing action. A packing action is determined from the candidate packing actions in the action space that corresponds to a largest reward value of the reward values. The first one of the to-be-packed patches is packed by adjusting a pose and a distance of the first one of the to-be-packed patches according to the determined packing action.

In an example, the determined packing action includes a translation action to reduce the spacing between the first one of the to-be-packed patches and the already-packed patches and a rotation action to adjust a pose of the first one of the to-be-packed patches. The determined packing action is applied to the first one of the to-be-packed patches according to a collision-constrained local optimization such that a COM of the first one of the to-be-packed patches and a COM of the already-packed patches is reduced to a predetermined value and the first one of the to-be-packed patches and the already-packed patches are not overlapped.

In an example, a packing ratio of the packed first subset of the packed L subsets is determined based on a ratio of an area of the first subset and an area of the first bounding box of the packed first subset. The area-averaged packing ratio associated with the packed first subset of the packed L subsets is determined based on a ratio of (i) a sum of areas of the UV patches in the super-patches that includes the packed first subset in the primary set and (ii) a sum of areas of subset bounding boxes of the super-patches that includes the packed first subset in the primary set.

In an aspect, the LPN is trained based on a Q-learning algorithm by maximizing an expected cumulative reward value. The expected cumulative reward value is defined as follows:

$${π}^{L P N} [ {Σ}_{i = 1}^{H} r ( {s}_{i} , {a}_{i} , {s}_{i + 1} ) ] .$$

i indicates an i-th patch of the to-be-packed patches. aᵢ indicates a determined packing action from the candidate packing actions that is applied to the i-th patch. r(sᵢ, aᵢ, sᵢ₊₁) indicates a reward value in response to the determined packing action being applied to the i-th patch. π^{LPN} indicates a probability that the determined packing action aᵢ is selected from the candidate packing actions. sᵢ indicates a state space before the i-th patch is packed to the already-packed patches. sᵢ₊₁ indicates a state space after the i-th patch is packed to the already-packed patches.

In an aspect, the HSN is trained. In order to train the HSN, a first estimated area-averaged packing ratio is determined for a first training subset from the primary set and a second estimated area-averaged packing ratio is determined for a second training subset from the primary set. A first area-averaged packing ratio for the first training subset and a second area-averaged packing ratio for the second training subset are further determined. The HSN is updated via a margin ranking loss, where the margin ranking loss being equal to:

$$ℒ = max ( 0 , - sgn ( {pr}^{′} - {pr}^{″} ) ( HSN ( {′}^{} ) - HSN ( {″}^{} ) ) + ϵ ) .$$

pr′ and HSN( [symbol] ′) are the first area-averaged packing ratio and the first estimated area-averaged packing ratio for the first subset respectively. pr″ and HSN( [symbol] ″) are the second area-averaged packing ratio and the second estimated area-averaged packing ratio for the second subset respectively. ∈ is a minimal positive margin.

In an example, the poses of the plurality of super-patches are adjusted by rotating and translating the plurality of the super-patches such that the spacing between the plurality of super-patches is reduced such that the first bounding box is reduced into a second bounding box. The second bounding box corresponds to a minimized bounding size according to an optimization function such that the plurality of super-patches in the second bounding box are not overlapped.

Then, the process proceeds to (S1099) and terminates.

The process (1000) can be suitably adapted. Step(s) in the process (1000) can be modified and/or omitted. Additional step(s) can be added. Any suitable order of implementation can be used.

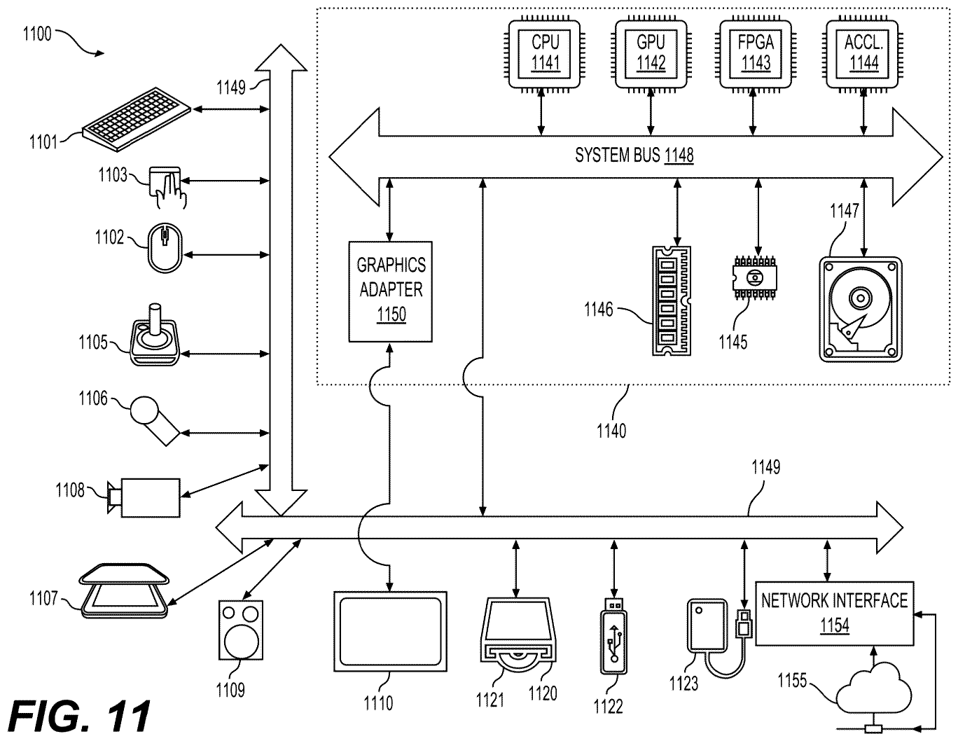

The techniques described above, can be implemented as computer software using computer-readable instructions and physically stored in one or more computer-readable media. For example, FIG. 11 shows a computer system (1100) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 11 for computer system (1100) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1100).

Computer system (1100) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1101), mouse (1102), trackpad (1103), touch screen (1110), data-glove (not shown), joystick (1105), microphone (1106), scanner (1107), camera (1108).

Computer system (1100) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1110), data-glove (not shown), or joystick (1105), but there can also be tactile feedback devices that do not serve as input devices), audio output devices (such as: speakers (1109), headphones (not depicted)), visual output devices (such as screens (1110) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1100) can also include human accessible storage devices and their associated media such as optical media including CD/DVD ROM/RW (1120) with CD/DVD or the like media (1121), thumb-drive (1122), removable hard drive or solid state drive (1123), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1100) can also include an interface (1154) to one or more communication networks (1155). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1149) (such as, for example USB ports of the computer system (1100)); others are commonly integrated into the core of the computer system (1100) by attachment to a system bus as described below (for example Ethernet interface into a PC computer system or cellular network interface into a smartphone computer system). Using any of these networks, computer system (1100) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1140) of the computer system (1100).

The core (1140) can include one or more Central Processing Units (CPU) (1141), Graphics Processing Units (GPU) (1142), specialized programmable processing units in the form of Field Programmable Gate Areas (FPGA) (1143), hardware accelerators for certain tasks (1144), graphics adapters (1150), and so forth. These devices, along with Read-only memory (ROM) (1145), Random-access memory (1146), internal mass storage such as internal non-user accessible hard drives, SSDs, and the like (1147), may be connected through a system bus (1148). In some computer systems, the system bus (1148) can be accessible in the form of one or more physical plugs to enable extensions by additional CPUs, GPU, and the like. The peripheral devices can be attached either directly to the core's system bus (1148), or through a peripheral bus (1149). In an example, the screen (1110) can be connected to the graphics adapter (1150). Architectures for a peripheral bus include PCI, USB, and the like.

CPUs (1141), GPUs (1142), FPGAs (1143), and accelerators (1144) can execute certain instructions that, in combination, can make up the aforementioned computer code. That computer code can be stored in ROM (1145) or RAM (1146). Transitional data can be also be stored in RAM (1146), whereas permanent data can be stored for example, in the internal mass storage (1147). Fast storage and retrieve to any of the memory devices can be enabled through the use of cache memory, that can be closely associated with one or more CPU (1141), GPU (1142), mass storage (1147), ROM (1145), RAM (1146), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1100), and specifically the core (1140) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1140) that are of non-transitory nature, such as core-internal mass storage (1147) or ROM (1145). The software implementing various embodiments of the present disclosure can be stored in such devices and executed by core (1140). A computer-readable medium can include one or more memory devices or chips, according to particular needs. The software can cause the core (1140) and specifically the processors therein (including CPU, GPU, FPGA, and the like) to execute particular processes or particular parts of particular processes described herein, including defining data structures stored in RAM (1146) and modifying such data structures according to the processes defined by the software. In addition or as an alternative, the computer system can provide functionality as a result of logic hardwired or otherwise embodied in a circuit (for example: accelerator (1144)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of processing a plurality of UV patches of a three-dimensional model, the method comprising:
dividing the plurality of UV patches into a primary set of the UV patches and a secondary set of the UV patches based on a patch size threshold;
grouping the UV patches of the primary set into a plurality of super-patches, each of the plurality of super-patches including different UV patches in the primary set that are packed together in a predefined shape;
assembling the plurality of super-patches together into a first bounding box;
adjusting poses of the plurality of super-patches to reduce spacing between the plurality of super-patches; and
filling gaps between the UV patches in the primary set with the UV patches in the secondary set.

2. The method of claim 1, wherein the grouping the UV patches of the primary set further comprises:
based on a high-level group selector network (HSN) configured to identify a subset from the primary set to from a super-patch of the plurality of super-patches,
selecting M subsets from the primary set, each of the M subsets including respective N UV patches, the M being a first positive integer, the N being a second positive integer smaller than M;
determining an estimated area-averaged packing ratio associated with each of the M subsets;
reordering the M subsets based on the estimated area-averaged packing ratios; and
determining L subsets from the M subsets that correspond to L largest estimated area-averaged packing ratios.

3. The method of claim 2, wherein the grouping the plurality of UV patches of the primary set further comprises:
packing the UV patches in each of the L subsets together into a respective subset bounding box;
determining an area-averaged packing ratio associated with each of the packed L subsets; and
determining a first super-patch of the plurality of super-patches from the packed L subsets, the first super-patch corresponding to a largest area-averaged packing ratio among the determined area-averaged packing ratios of the packed L subsets.

4. The method of claim 3, wherein:
the packing the UV patches in each of the L subsets together into the respective subset bounding box further includes packing the UV patches in a first subset of the L subsets into a first subset bounding box, and
the packing the UV patches in the first subset of the L subsets into the first subset bounding box further includes:
based on a low-level sorter network (LSN) that is configured to determine a packing order of the UV patches in the first subset,
organize the UV patches in the first subset into a connected graph in which already- packed patches and to-be-packed patches of the first subset are connected to each other;
inputting node features of the UV patches in the first subset into a graph attention network (GAT) to obtain graph features of the UV patches of the first subset;
converting the graph features to corresponding Q-values via a multilayer perceptron (MLP) that includes an input layer and an output layer, and one or more hidden layers with stacked neurons; and
determining a first one of the to-be-packed patches to pack to the already-packed patches based on the Q-values.

5. The method of claim 4, wherein the node features of the UV patches of the first subset are determined based on a fully convolutional network (FCN) in which the UV patches of the first subset are encoded into a F-dimensional latent space, the F being a positive integer.

6. The method of claim 4, where the packing the UV patches in the first subset of the L subsets further comprises:
based on a low-level pose network (LPN) that is configured to determine a pose of a UV patch in the primary set,
determining a state space, the state space indicating position states of the already-packed patches and the to-be-packed patches in the first subset;
determining an action space for the to-be-packed patches, the action space indicating candidate packing actions for the to-be-packed patches;
applying each of the candidate packing actions in the action space on the first one of the to-be-packed patches;
determining an updated state space corresponding to each of the candidate packing actions that is applied on the first one of the to-be-packed patches;
determining a reward value corresponding to each of the updated state spaces associated with the first one of the to-be-packed patches, each of the reward values corresponding to an area-average packing ratio associated with the respective candidate packing action;
determining a packing action from the candidate packing actions in the action space that corresponds to a largest reward value of the reward values; and
packing the first one of the to-be-packed patches by adjusting a pose and a distance of the first one of the to-be-packed patches according to the determined packing action.

7. The method of claim 6, wherein:
the determined packing action includes a translation action to reduce the spacing between the first one of the to-be-packed patches and the already-packed patches and a rotation action to adjust a pose of the first one of the to-be-packed patches, and
the determined packing action is applied to the first one of the to-be-packed patches according to a collision-constrained local optimization such that a center-of-mass (COM) of the first one of the to-be-packed patches and a COM of the already-packed patches is reduced to a predetermined value and the first one of the to-be-packed patches and the already-packed patches are not overlapped.

8. The method of claim 4, wherein the determining the area-averaged packing ratio associated with each of the packed L subsets further comprises:
determining a packing ratio of the packed first subset of the packed L subsets based on a ratio of an area of the first subset and an area of the first bounding box of the packed first subset; and
determining the area-averaged packing ratio associated with the packed first subset of the packed L subsets based on a ratio of (i) a sum of areas of the UV patches in the super-patches that includes the packed first subset in the primary set and (ii) a sum of areas of subset bounding boxes of the super-patches that includes the packed first subset in the primary set.

9. The method of claim 6, further comprising:
training the LPN based on a Q-learning algorithm by maximizing an expected cumulative reward value, wherein the expected cumulative reward value is defined as:
$${π}^{L P N} [ {Σ}_{i = 1}^{H} r ( {s}_{i} , {a}_{i} , {s}_{i + 1} ) ] ,$$
i indicating an i-th patch of the to-be-packed patches, aᵢ indicating a determined packing action from the candidate packing actions that is applied to the i-th patch, r (sᵢ, ai, sᵢ₊₁) indicating a reward value in response to the determined packing action being applied to the i-th patch, π^{LPN} indicating a probability that the determined packing action aᵢ is selected from the candidate packing actions, sᵢ indicating a state space before the i-th patch is packed to the already-packed patches, sᵢ₊₁ indicating a state space after the i-th patch is packed to the already-packed patches.

10. The method of claim 2, further comprising:
training the HSN, and
the training the HSN further includes:
determining a first estimated area-averaged packing ratio for a first training subset from the primary set and a second estimated area-averaged packing ratio for a second training subset from the primary set;
determining a first area-averaged packing ratio for the first training subset and a second area-averaged packing ratio for the second training subset; and
updating the HSN via a margin ranking loss, the margin ranking loss being equal to [symbol] =max(0,−sgn(pr′−pr″)(HSN( [symbol] ′)−HSN( [symbol] ″))+∈), pr′ and HSN( [symbol] ′) being the first area-averaged packing ratio and the first estimated area-averaged packing ratio for the first subset respectively, pr″ and HSN( [symbol] ″) being the second area-averaged packing ratio and the second estimated area-averaged packing ratio for the second subset respectively, e being a minimal positive margin.

11. The method of claim 1, wherein the adjusting further comprises:
adjusting the poses of the plurality of super-patches by rotating and translating the plurality of the super-patches such that the spacing between the plurality of super-patches is reduced such that the first bounding box is reduced into a second bounding box, the second bounding box corresponding to a minimized bounding size according to an optimization function such that the plurality of super-patches in the second bounding box are not overlapped.

12. An apparatus, the apparatus comprising:
processing circuitry configured to:
divide a plurality of UV patches of a three-dimensional model into a primary set of the UV patches and a secondary set of the UV patches based on a patch size threshold;
group the UV patches of the primary set into a plurality of super-patches, each of the plurality of super-patches including different UV patches in the primary set that are packed together in a predefined shape;
assemble the plurality of super-patches together into a first bounding box;
adjust poses of the plurality of super-patches to reduce spacing between the plurality of super-patches; and
fill gaps between the UV patches in the primary set with the UV patches in the secondary set.

13. The apparatus of claim 12, wherein the processing circuitry is configured to:
based on a high-level group selector network (HSN) configured to identify a subset from the primary set to from a super-patch of the plurality of super-patches,
select M subsets from the primary set, each of the M subsets including respective N UV patches, the M being a first positive integer, the N being a second positive integer smaller than M;
determine an estimated area-averaged packing ratio associated with each of the M subsets;
reorder the M subsets based on the estimated area-averaged packing ratios; and
determine L subsets from the M subsets that correspond to L largest estimated area-averaged packing ratios.

14. The apparatus of claim 13, wherein the processing circuitry is configured to:
pack the UV patches in each of the L subsets together into a respective subset bounding box;
determine an area-averaged packing ratio associated with each of the packed L subsets; and
determine a first super-patch of the plurality of super-patches from the packed L subsets, the first super-patch corresponding to a largest area-averaged packing ratio among the determined area-averaged packing ratios of the packed L subsets.

15. The apparatus of claim 14, wherein:
the L subsets includes a first subset, and
the processing circuitry is configured to:
based on a low-level sorter network (LSN) that is configured to determine a packing order of the UV patches in the first subset,
organize the UV patches in the first subset into a connected graph in which already-packed patches and to-be-packed patches of the first subset are connected to each other;
input node features of the UV patches in the first subset into a graph attention network (GAT) to obtain graph features of the UV patches of the first subset;
convert the graph features to corresponding Q-values via a multilayer perceptron (MLP) that includes an input layer and an output layer, and one or more hidden layers with stacked neurons; and
determine a first one of the to-be-packed patches to pack to the already-packed patches based on the Q-values.

16. The apparatus of claim 15, wherein the node features of the UV patches of the first subset are determined based on a fully convolutional network (FCN) in which the UV patches of the first subset are encoded into a F-dimensional latent space, the F being a positive integer.

17. The apparatus of claim 15, wherein the processing circuitry is configured to:
based on a low-level pose network (LPN) that is configured to determine a pose of a UV patch in the primary set,
determine a state space, the state space indicating position states of the already-packed patches and the to-be-packed patches in the first subset;
determine an action space for the to-be-packed patches, the action space indicating candidate packing actions for the to-be-packed patches;
apply each of the candidate packing actions in the action space on the first one of the to-be-packed patches;
determine an updated state space corresponding to each of the candidate packing actions that is applied on the first one of the to-be-packed patches;
determine a reward value corresponding to each of the updated state spaces associated with the first one of the to-be-packed patches, each of the reward values corresponding to an area-average packing ratio associated with the respective candidate packing action;
determine a packing action from the candidate packing actions in the action space that corresponds to a largest reward value of the reward values; and
pack the first one of the to-be-packed patches by adjusting a pose and a distance of the first one of the to-be-packed patches according to the determined packing action.

18. The apparatus of claim 17, wherein:
the determined packing action includes a translation action to reduce the spacing between the first one of the to-be-packed patches and the already-packed patches and a rotation action to adjust a pose of the first one of the to-be-packed patches, and
the determined packing action is applied to the first one of the to-be-packed patches according to a collision-constrained local optimization such that a center-of-mass (COM) of the first one of the to-be-packed patches and a COM of the already-packed patches is reduced to a predetermined value and the first one of the to-be-packed patches and the already-packed patches are not overlapped.

19. The apparatus of claim 15, wherein the processing circuitry is configured to:
determine a packing ratio of the packed first subset of the packed L subsets based on a ratio of an area of the first subset and an area of the first bounding box of the packed first subset; and
determine the area-averaged packing ratio associated with the packed first subset of the packed L subsets based on a ratio of (i) a sum of areas of the UV patches in the super-patches that includes the packed first subset in the primary set and (ii) a sum of areas of subset bounding boxes of the super-patches that includes the packed first subset in the primary set.

20. The apparatus of claim 17, wherein the processing circuitry is configured to:
train the LPN based on a Q-learning algorithm by maximizing an expected cumulative reward value, wherein the expected cumulative reward value is defined as:
$${π}^{L P N} [ {Σ}_{i = 1}^{H} r ( {s}_{i} , {a}_{i} , {s}_{i + 1} ) ] ,$$
i indicating an i-th patch of the to-be-packed patches, aᵢ indicating a determined packing action from the candidate packing actions that is applied to the i-th patch, r (sᵢ, ai, sᵢ₊₁) indicating a reward value in response to the determined packing action being applied to the i-th patch, ILPN indicating a probability that the determined packing action aᵢ is selected from the candidate packing actions, sᵢ indicating a state space before the i-th patch is packed to the already-packed patches, sᵢ₊₁ indicating a state space after the i-th patch is packed to the already-packed patches.
